(19) United States
(12) Patent Application Publication
(10) Pub. No.: US 2017/0300183 A1
(43) Pub. Date: Oct. 19, 2017

(54) Tab Snooze and Reminders

(71) Applicant: Microsoft Technology Licensing, LLC, Redmond, WA (US)

(72) Inventors: Adam Barrus, Redmond, WA (US); Kimberly Tee, Kitchener (CA); Michael Patten, Sammamish, WA (US); Matthew Duignan, Seattle, WA (US); James Humphrey, Redmond, WA (US)

(73) Assignee: Microsoft Technology Licensing, LLC, Redmond, WA (US)

(21) Appl. No.: 15/098,308

(22) Filed: Apr. 13, 2016

(51) Int. Cl. G06F 3/0482; H04L 29/08

(52) U.S. Cl. CPC G06F 3/0482; H04L 67/22; H04L 67/02; H04L 67/18

(57) ABSTRACT

In one example, a computing device, such as a mobile communication device may use an electronic assistant module to set a tab snooze when viewing a web page. The computing device may store in the electronic assistant module a web page associated with a trigger condition describing a trigger event. The computing device may register a computing event has occurred. The computing device may identify the computing event as the trigger event. The electronic assistant module of the computing device may trigger presentation of the web page to the user based on the trigger event. The computing device may present the web page to a user upon triggering.

### BACKGROUND

A computing device may use a browser module to access a web page stored on a web server. The browser module may maintain one or more tabs to keep multiple web pages active for presentation to the user. The user may switch between tabs to view different web pages. The browser module may present a cached version of the web page to the user upon selection of a tab associated with that web page. If a suitable period of time has passed, the browser module may refresh the web page by checking with the associated server to determine whether the content of the web page has been updated.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Examples discussed below relate to using an electronic assistant module to set a tab snooze when viewing a web page. The computing device may store in the electronic assistant module a web page associated with a trigger condition describing a trigger event. The computing device may register a computing event has occurred. The computing device may identify the computing event as the trigger event. The electronic assistant module of the computing device may trigger presentation of the web page to the user based on the trigger event. The computing device may present the web page to a user upon triggering.

### DRAWINGS

In order to describe the manner in which the above-recited and other advantages and features can be obtained, a more particular description is set forth and will be rendered by reference to specific examples thereof which are illustrated in the appended drawings. Understanding that these drawings depict only typical examples and are not therefore to be considered to be limiting of its scope, implementations will be described and explained with additional specificity and detail through the use of the accompanying drawings.

FIG. 1 illustrates, in a block diagram, one example of a data network.

FIG. 2 illustrates, in a block diagram, one example of a computing device.

FIG. 3 illustrates, in a block diagram, one example of a computing device architecture.

FIG. 4 illustrates, in a block diagram, one example of a browser module interface.

FIG. 5 illustrates, in a block diagram, one example of an electronic assistant module interface.

FIG. 6 illustrates, in a flowchart, one example of a method for setting a tab snooze based on a generic trigger condition.

FIG. 7 illustrates, in a flowchart, one example of a method for activating a tab presentation based on a generic trigger condition.

FIG. 8 illustrates, in a block diagram, one example of geographic location event.

FIG. 9 illustrates, in a flowchart, one example of a method for setting a tab snooze based on a trigger location.

FIG. 10 illustrates, in a flowchart, one example of a method for activating a tab presentation based on a trigger location.

FIG. 11 illustrates, in a flowchart, one example of a method for setting a tab snooze based on a trigger time.

FIG. 12 illustrates, in a flowchart, one example of a method for activating a tab presentation based on a trigger time.

FIG. 13 illustrates, in a flowchart, one example of a method for setting a tab snooze based on a trigger device.

FIG. 14 illustrates, in a flowchart, one example of a method for activating a tab presentation based on a trigger device.

FIG. 15 illustrates, in a flowchart, one example of a method for setting a tab snooze based on a form factor trigger.

FIG. 16 illustrates, in a flowchart, one example of a method for activating a tab presentation based on a form factor trigger.

### DETAILED DESCRIPTION

Examples are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a mobile communication device, a computing device, or a machine-implemented method.

In one example, a computing device, such as a mobile communication device may use an electronic assistant module to set a tab snooze when viewing a web page. The computing device may store in the electronic assistant module a web page associated with a trigger condition describing a trigger event. The computing device may register a computing event has occurred. The computing device may identify the computing event as the trigger event. The electronic assistant module of the computing device may trigger presentation of the web page to the user based on the trigger event. The computing device may present the web page to a user upon triggering.

Many users may maintain tabs in a browser as a “to do” list. A user may not close the tab until the task is complete. Users may leave tabs open in a browser window indefinitely to allow easy location by the user. However, the user may experience anxiety based on the open tab. A user may develop a workaround for this anxiety, by saving sites on a website favorite list or self-emailing a uniform resource locator for the tab. However a user may still forget to take action on a “saved” site.

A user may select an active web site in an open tab in a browser window. The selection may be via a right-click context menu, a pinned on-object user interface, an on-object user interface that appears on hover by the cursor or touch by a finger on a touch screen, or a pre-identified gesture, such as a swiping motion in a specified direction. From that selection user interface, the user may choose to set a tab to dormant, or “snooze”, for later. The user may snooze the tab until a trigger event occurs, such as a specific time, a physical location, another user is present, or a device with a better form factor is activated. The tab may then disappear from the browser window. An electronic assistant module may maintain a list of “snoozed tabs” accessible from within the browser or the electronic assistant module at any time. Alternately, a browser via a plug-in, a device application, or an operating system may store the snoozed tab list. When the trigger event occurs, such as a specified time, a specified physical location, optimal form factor, or another device associated with the user via the electronic assistant module may fire a notification for the previously snoozed tab. By acting on the notification, the computing device may open the uniform resource locator of the previously snoozed tab in the browser on the target device, which may be a computing device or a mobile device.

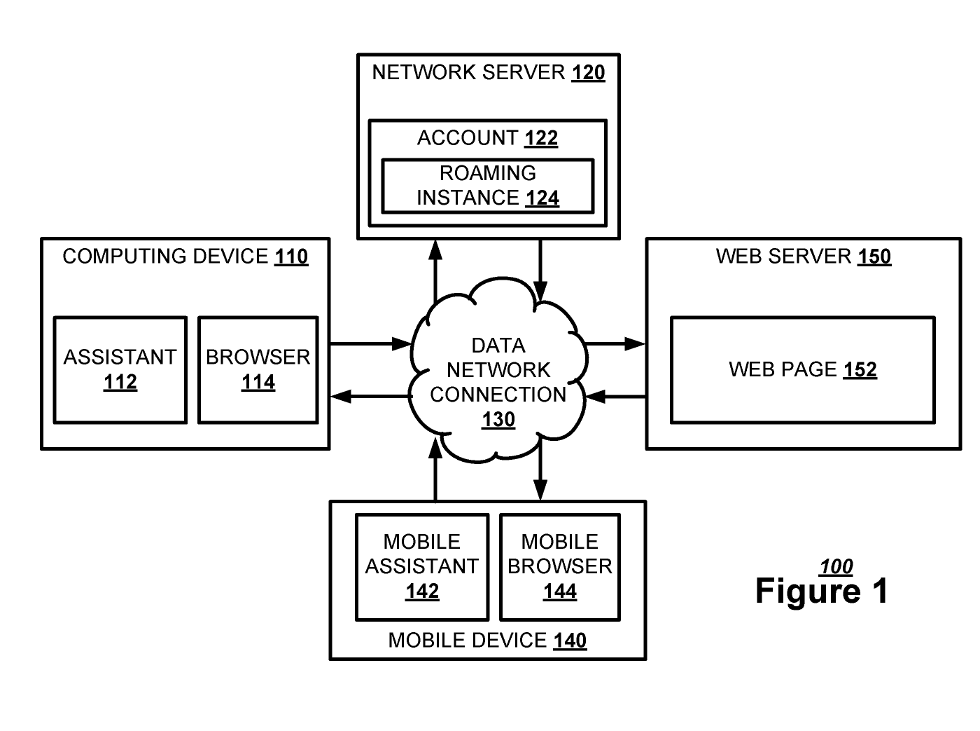

A computing device may use a data network to access a web page. FIG. 1 illustrates, in a block diagram, one example of a data network 100. A user may use a computing device 110 to implement an electronic assistant module 112, such as Siri® or Cortana®, to coordinate various modules to perform business and lifestyle functions. The computing device 110 may be a personal computer, a laptop, a tablet, a mobile phone, a game console, a smart watch, or other computing device that may connect with another computing device. The electronic assistant module 112 may provide both a graphic user interface and a verbal user interface to interact with a user.

The electronic assistant module 112 may coordinate with a network service server 120 via a data network connection 130 to coordinate instances of the electronic assistant module 112 across different devices owned by the user. The network services server 120 may be implemented on a single server or a distributed set of servers, such as a server farm. The network services server 120 may have an online user account 122 for the user that maintains a roaming instance 124 of the electronic assistant module. The data network connection 130 may be an internet connection, a wide area network connection, a local area network connection, or other type of data network connection.

For example, the user may have a mobile device 140 in addition to the computing device 110. The user may have a mobile electronic assistant instance 142 operating on the mobile device 140. The mobile electronic assistant instance 142 may configure the mobile device 140 to match operations on the computing device 110. The mobile electronic assistant instance 142 may transfer data from the computing device 110 to the mobile device 140, such as calendar data or to do lists.

A user may use the computing device 110 to implement a browser module 114 to access content on the internet. The browser module 114 may access a web server 150 via a data network connection 130 to download a web page 152. The web server 150 may be implemented on a single server or a distributed set of servers, such as a server farm. The mobile electric assistant instance 142 may transfer a web page 152 viewed on the browser module 114 to the mobile device 140 for viewing on a mobile browser module 144.

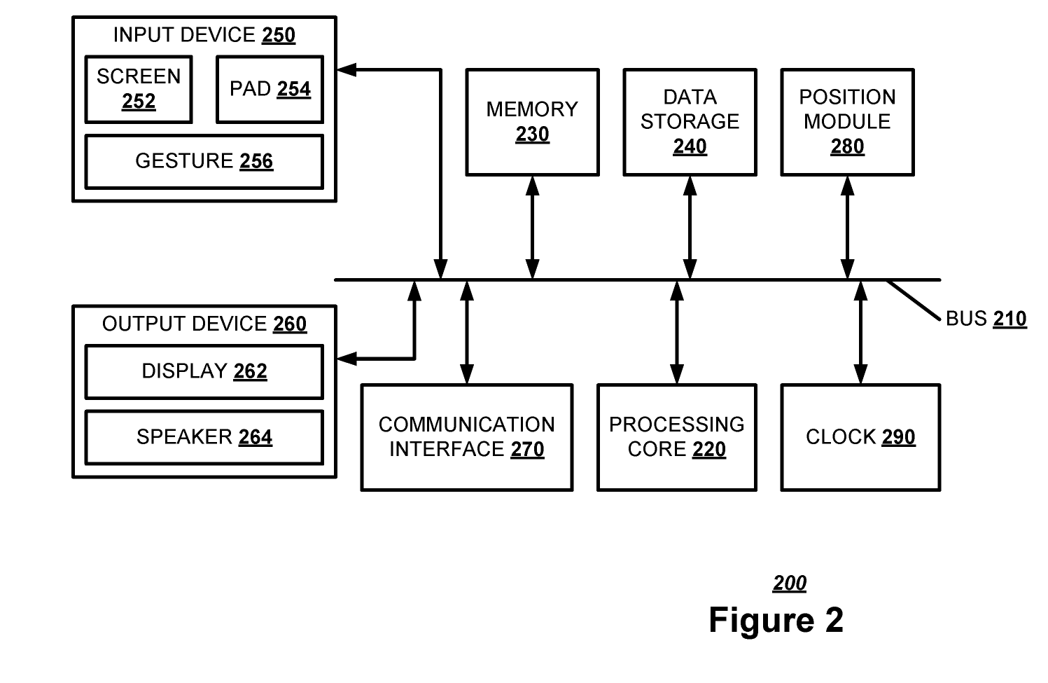

FIG. 2 illustrates a block diagram of an exemplary computing device 200 which may act as a mobile communication device. The computing device 200 may combine one or more of hardware, software, firmware, and system-on-a-chip technology to implement a mobile communication device. The computing device 200 may include a bus 210, a processing core 220, a memory 230, a data storage 240, an input device 250, an output device 260, a communication interface 270 a geographic positioning module 280, and a clock 290. The bus 210, or other component interconnection, may permit communication among the components of the computing device 200.

The processing core 220 may include at least one conventional processor or microprocessor that interprets and executes a set of instructions. The processing core 220 may be configured to execute an electronic assistant module to track the web page. The processing core 220 may be further configured to register a computing event has occurred, such as a geographic location identification, a time reading, or a computing device activating. The processing core 220 may be also configured to compare the computing event, such as the geographic location, to a trigger condition, such as a trigger location. The processing core may be additionally configured to identify a computing event as a trigger event. The processing core 220 may be further configured to identify a content type for the web page. The processing core 220 may be also configured to set a location type as the trigger condition based on a content type for the web page. The processing core 220 may be configured to execute the electronic assistant module to trigger presentation of the web page to the user based on the trigger event.

The memory 230 may be a random access memory (RAM) or another type of dynamic data storage that stores information and instructions for execution by the processor 220. The memory 230 may also store temporary variables or other intermediate information used during execution of instructions by the processor 220. The memory 230 may store a series of instructions that when implemented by a processing core 220 implement an electronic assistant module. The memory may be configured to associate a web page with a trigger condition describing a trigger event, such as a trigger location, a trigger time, a device trigger, a form factor trigger, or a content trigger. The memory may be further configured to store a generic constraint for the trigger condition, such as a time range describing when a trigger location triggers presenting the web page and a location range describing where a trigger event triggers presenting the web page.

The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for storing data from the electronic assistant module.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The input device 250 may be configured to receive a page indication identifying the web page. The input device 250 may be configured to receive a trigger indication describing the trigger condition. The input device 250 may be configured to receive a constraint indication inputting a constraint describing exceptions to the trigger conditions.

The output device 260 may include one or more conventional mechanisms that output information to the user, including a display screen 262, a printer, one or more speakers 264, a headset, a vibrator, or a medium, such as a memory, or a magnetic or optical disk and a corresponding disk drive. A display screen 262 may be configured to present the web page to a user on a computing device 200, such as a mobile communication device, based on the trigger event, such as a geographic location.

The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface 270 may be configured to connect to an online user account for a network service using an electronic assistant module. The communication interface 270 may be further configured to receive the web page and the trigger condition in the electronic assistant module from a network service.

The geographic positioning module 280 may use location data, such as coordinates from a geographic positioning system (GPS), to determine the location of the computing device 200. The geographic positioning module 280 may be configured to determine a geographic location of a computing device 200, such as a mobile communication device. The clock 290 may provide a time and date to the computing device 200. The clock 290 may be configured to provide a time to the electronic assistant module to determine whether a trigger time has occurred.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

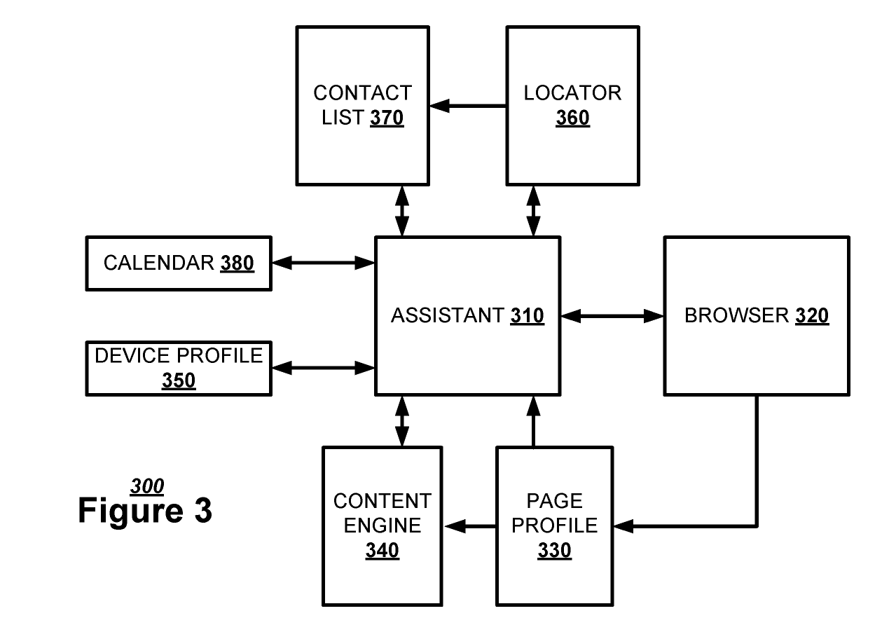

FIG. 3 illustrates, in a block diagram, one example of a computing device architecture 300. The computing device may have an electronic assistant module 310 to coordinate interactions between different modules in a computing device. The computing device may have a browser module 320 to access a web page on a web server over a data network. The browser module 320 may manage multiple pages at once using a tab system. Each tab represents an active web page, ready to be presented to the user. Using the electronic assistant module 310, the user may set the web page to dormant, or snooze, in the tab system until more opportune circumstances are available. The user may set those circumstances directly, or the electronic assistance module 310 may determine those circumstances based on the web page and user context. By managing the tab snooze in the electronic assistant module 310 instead of the browser module 320, the electronic assistant module 310 may propagate the tab snooze across the user experience and take the totality of the user experience into account.

The browser module 320 may download a page profile 330 describing the content and the formatting of the web page from the web server or an exterior search engine. The browser module 320 may provide the page profile 330 to the electronic assistant module 310 and a content engine 340. The electronic assistant module 310 may compare the formatting data for the web page to a device profile 350 to determine whether the computing device may sufficiently present the web page, or whether other devices associated with the user may be better suited.

The content engine 340 may parse the page profile 330 to identify content present in the web page to the electronic assistant module 310. The electronic assistant module 310 may identify locations and time constraints associated with that content. For example, for a web page describing gardening equipment, the electronic assistant module 310 may identify nearby hardware stores. The electronic assistant module 310 may consult a locator module 360 to determine when the computing device is in the same area as location associated with the content, such as the hardware stores described above. When the location matches the content, the electronic assistant module 310 may have the browser module 320 present the web page tab again.

Further, the electronic assistant module 310 may have access to a contact list 370 for the user. The user may identify for the electronic assistant module 310 a member of the contact list 370 that the user wants to show a web page. When the locator module 360 identifies the presence of a friend device paired with the contact list 370 member, the electronic assistant module 310 may have the browser module 320 present the web page tab again.

Alternately, for a movie set to open in two weeks, the electronic assistant module 310 may use a calendar module 380 to set a future alert for two weeks in the future. Upon the alert, the electronic assistant module 310 may have the browser module 320 present the web page tab again.

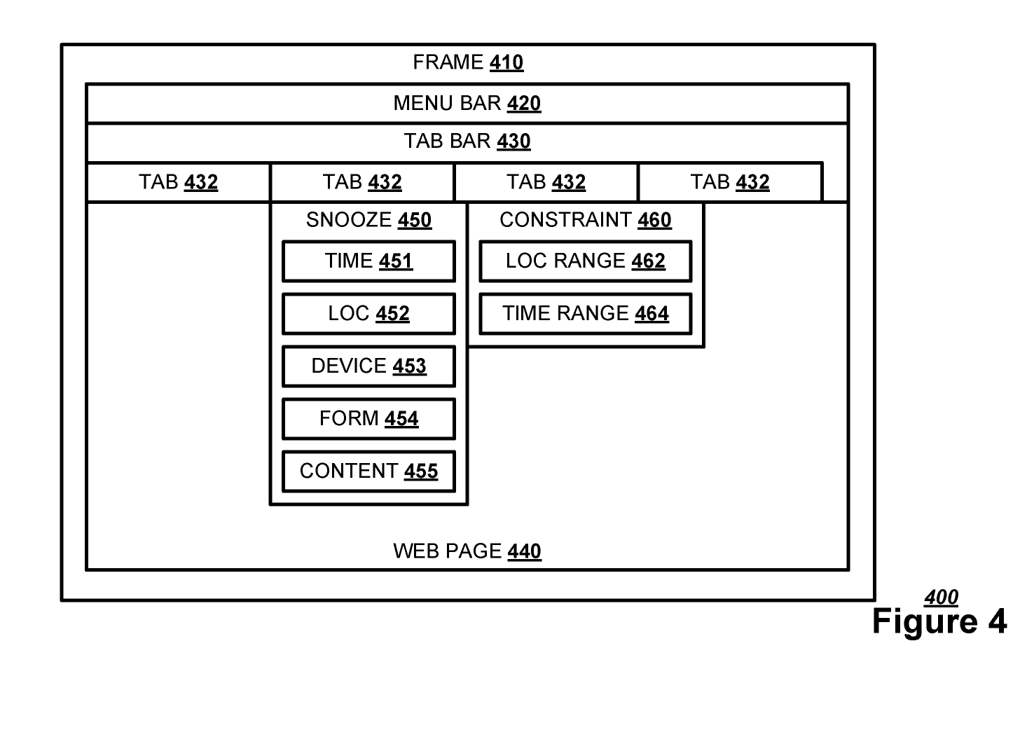

The user may set the tab snooze in the browser module. FIG. 4 illustrates, in a block diagram, one example of a browser module interface 400. The browser module interface 400 may have a frame 410 containing the user interface. The frame 410 may have a menu bar 420 providing controls for operating the browser module. The menu bar 420 may be hidden when not in use or may be present the entire time the browser module is active. The browser module may have a tab bar 430 presenting one or more tabs 432. Each tab 432 may represent a web page 440. Upon selection of the tab 432 by the user, the browser module may present the associated web page 440 to the user.

A tab 432 may have a snooze control 450, allowing the user to set the tab to dormant until a trigger condition causes the tab 432 to be presented to the user. The tab 432 may refresh the web page 440 upon activation to check for any updates to the web page 440 at the server. The snooze control 450 may set the tab snooze with a trigger condition based on a trigger time 451, a trigger location (LOC) 452, a device trigger 453, a form factor trigger 454, or a content trigger 455. A trigger time 451 may activate a dormant web page 440 when a time set by the user occurs. A trigger location 452 may activate a dormant web page 440 when a mobile device associated with the user comes within a specific range of a location set by the user. A device trigger 453 may identify a device associated with another user is in close proximity to the user device, so that the user may show the web page 440 to the other user. A form factor trigger 454 may activate a dormant web page 440 when a device associated with the user that has the appropriate form factor for the web page is activated. A content trigger 455 may extrapolate from the content or format of a web page 440 to identify a trigger time 451, a trigger location 452, a device trigger 453, or a form factor trigger 454.

A tab 432 may have a constraint control 460, allowing the user to carve out exceptions to various trigger conditions. The constraint control 460 may set a location range constraint 462 or a time range constraint 464. A location range constraint 462 may specify the distance that a mobile device may be from a location trigger to cause the web page 440 to be activated. A time range constraint 264 may specify the times when a trigger condition may cause a web page 440 to be activated.

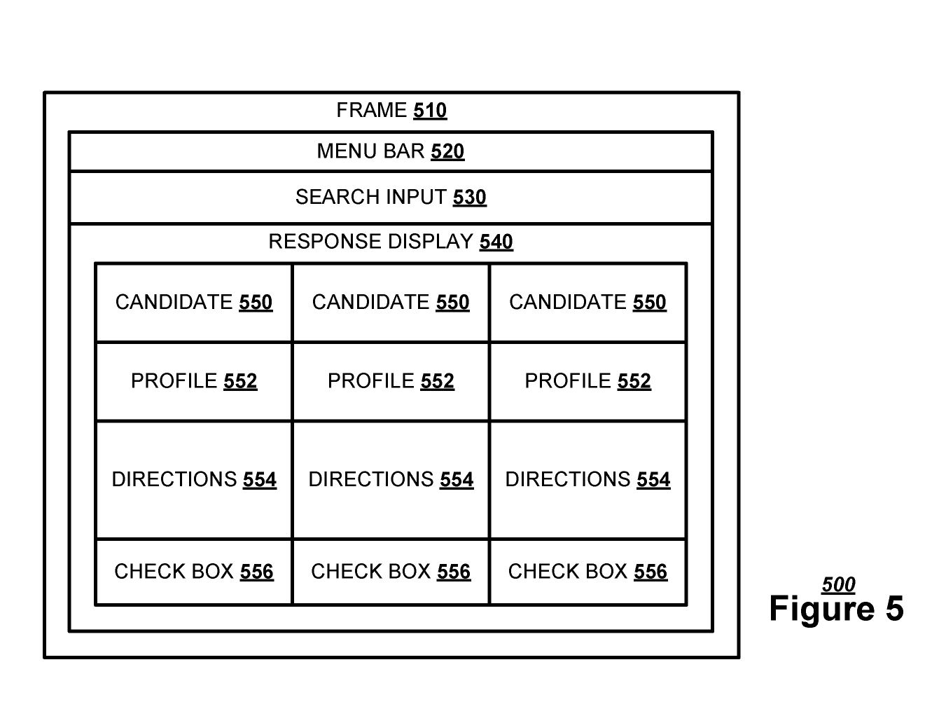

The electronic assistant module may be used to set a tab snooze without even entering the browser module. FIG. 5 illustrates, in a block diagram, one example of an electronic assistant module interface 500. The electronic assistant module interface 500 may have a frame 510 containing the user interface. The frame 510 may have a menu bar 520 providing controls for operating the electronic assistant module. The menu bar 520 may be hidden when not in use or may be present the entire time the electronic assistant module is active. The electronic assistant module may have a search input 530 to receive a search term from the user.

The user interface of the electronic assistant module may have a response display 540 presenting results to the search term. The response display 540 may present one or more candidate responses 550 for the search term. The candidate response 550 may have a profile 552 describing the content of the candidate response 550. The candidate response 550 may have directions 554 to a location associated with each candidate response 550. The candidate response 550 may have a check box 556 allowing the user to select a candidate response 550.

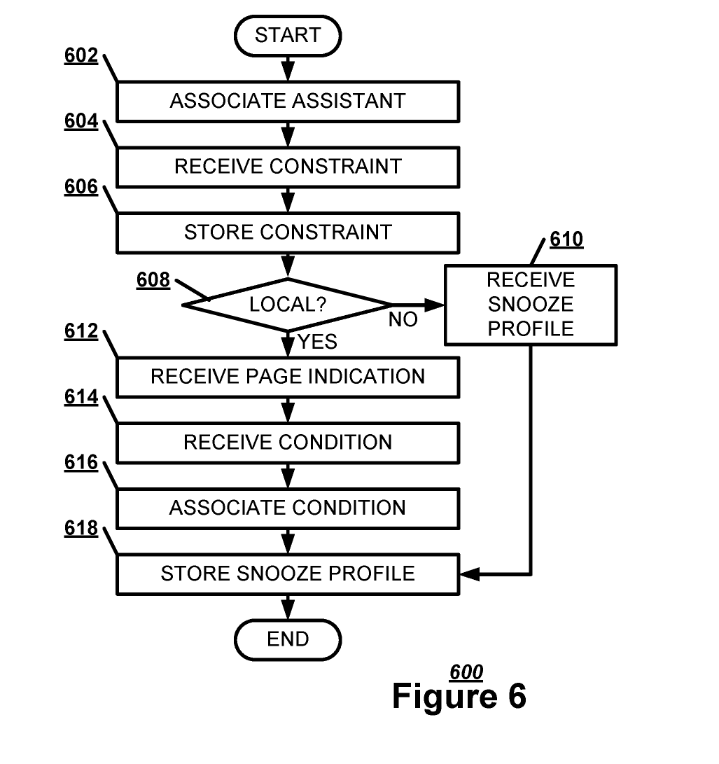

FIG. 6 illustrates, in a flowchart, one example of a method 600 for setting a tab snooze based on a generic trigger condition. An electronic assistant module of a computing device, such as a mobile communication device, may associate with an online user account for a network service (Block 602). The electronic assistant module may receive a generic constraint describing conditions for a trigger condition to be in effect for a tab snooze from the network service (Block 604). The electronic assistant module may store a generic constraint for a tab snooze on the local device (Block 606). If a different computing device associated with the user has set a tab snooze (Block 608), the electronic assistant module may receive a snooze profile having a web page and a generic trigger condition from a network service (Block 610). Otherwise, the electronic assistant module or a browser module may receive a page indication identifying a web page (Block 612). The electronic assistant module or the browser module may receive a trigger indication describing a generic trigger condition (Block 614). The electronic assistant module may associate the generic trigger condition with the web page (Block 616). The electronic assistant module may store a snooze profile having the web page associated with a generic trigger condition describing a trigger event (Block 618).

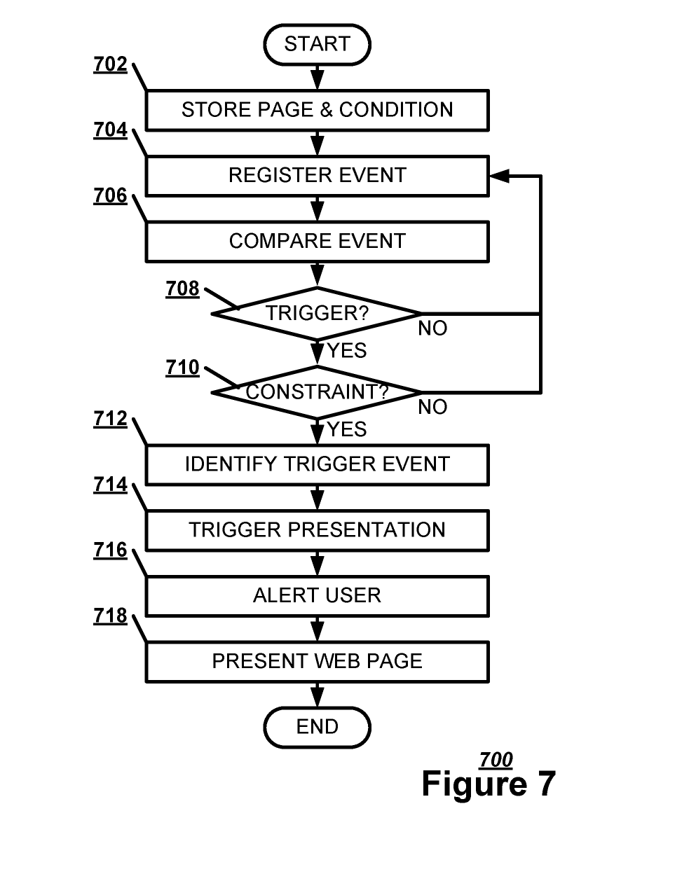

FIG. 7 illustrates, in a flowchart, one example of a method 700 for activating a tab presentation based on a generic trigger condition. The electronic assistant module may store a snooze profile having a web page and a generic trigger condition describing a trigger event (Block 702). The electronic assistant module may register that a computing event has occurred (Block 704). The electronic assistant module may compare the computing event to the trigger condition (Block 706). If the computing event meets the trigger condition (Block 708), and the computing event is within the trigger constraint (Block 710), the electronic assistant module may identify the computing event as a trigger event (Block 712). The electronic assistant module may trigger presentation of the web page by the browser module to the user based on the trigger event (Block 714). The electronic assistant module may alert the user that the web page is available prior to presentation of the web page to the user (Block 716). The browser module may present the web page to a user upon triggering based on the trigger event (Block 718).

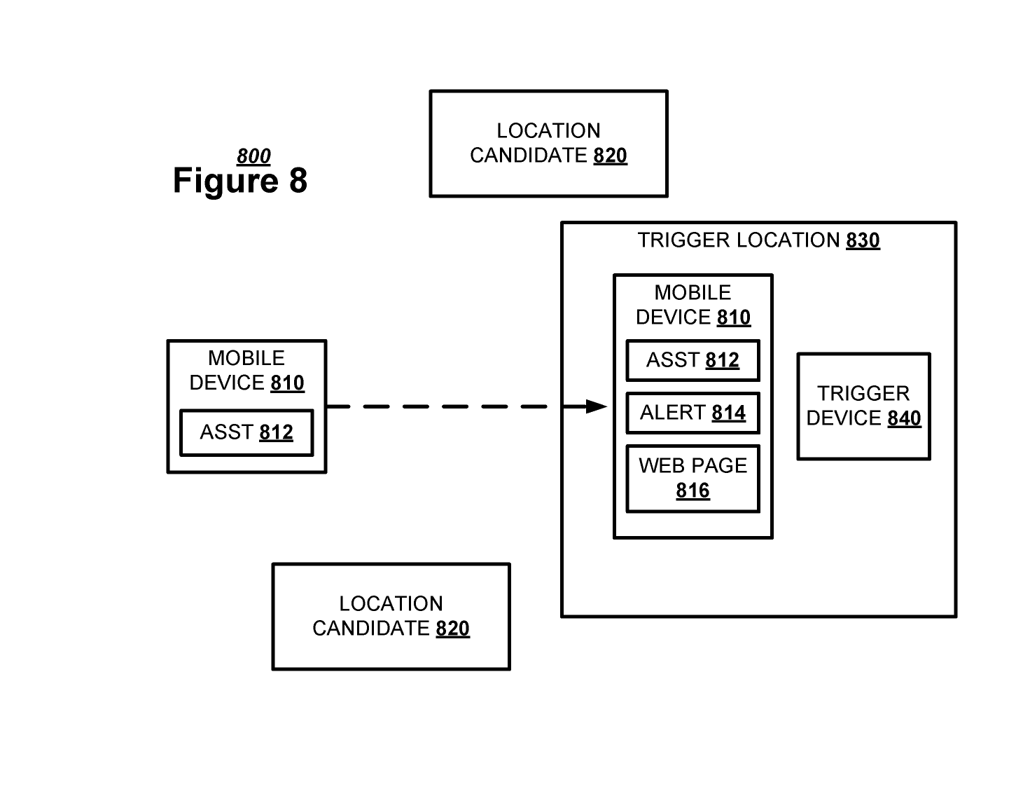

FIG. 8 illustrates, in a block diagram, one example of geographic location event 800. A mobile device 810 may implement an electronic assistant module 812 to coordinate interactions with other application modules. The user may travel to one or more location candidates 820. When the mobile device 810 reaches a trigger location 830 among the location candidates 820, the trigger location 830 may cause the mobile device 810 to present an alert 814 to the user that a web page 816 is available for presentation on the browser module to the user. The mobile device 810 may also present the web page 816 without first providing the alert 814.

Alternately, a user may wish to show the web page 816 to a friend, acquaintance, colleague, classmate, or family member. The user may select the other user from a contact list of the original user. The contact list may associate a friend device with the contact list member. When the friend device is within a geographic proximity of the mobile device 810, the friend device may act as a trigger device 840, causing the mobile device 810 to present the web page 816 to the user. The mobile device 810 may use a global positioning system module, a Bluetooth® communication, or a local area network presence to determine a geographic proximity.

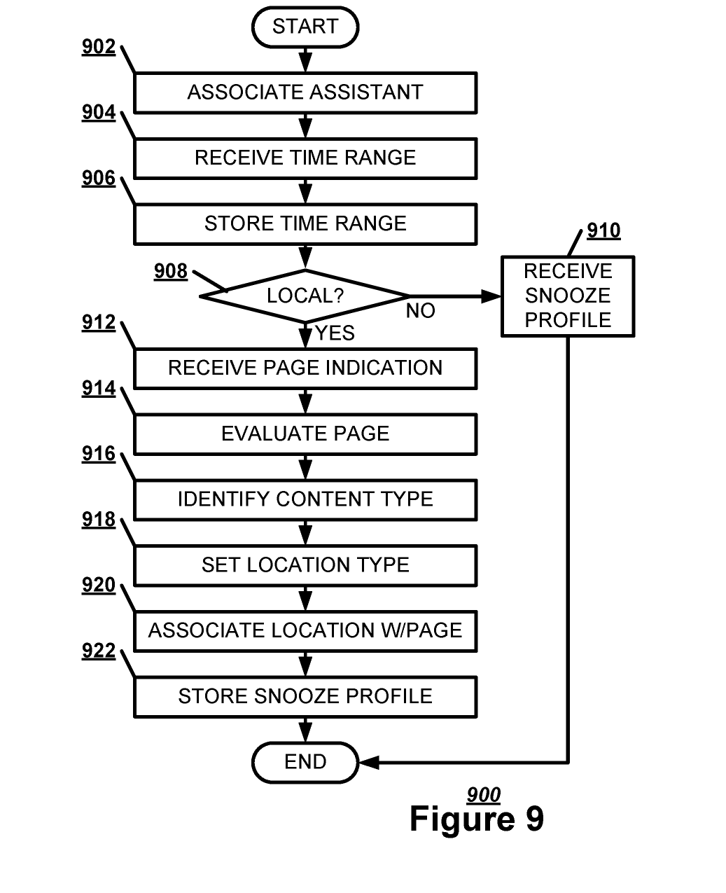

FIG. 9 illustrates, in a flowchart, one example of a method 900 for setting a tab snooze based on a trigger location. An electronic assistant module executed by a mobile communication device may associate with an online user account for a network service (Block 902). The electronic assistant module may receive a time range describing when a trigger location triggers presenting a web page from the network service (Block 904). The electronic assistant module may store a time range describing when a trigger location triggers presenting a web page (Block 906). If a different computing device associated with the user has set a tab snooze (Block 908), the electronic assistant module may receive a snooze profile having a web page and a trigger condition describing a trigger location from a network service (Block 910). Otherwise, the electronic assistant module or a browser module may receive a page indication identifying a web page (Block 912). The electronic assistant module or the browser module may evaluate a web page based on a page profile (Block 914). The electronic assistant module may identify a content type for the web page (Block 916). The electronic assistant module may set a location type as the trigger condition based on a content type for the web page (Block 918). The electronic assistant module may associate the trigger condition describing a trigger location with the web page (Block 920). The electronic assistant module may store a snooze profile having the web page associated with the trigger condition describing a trigger location (Block 922).

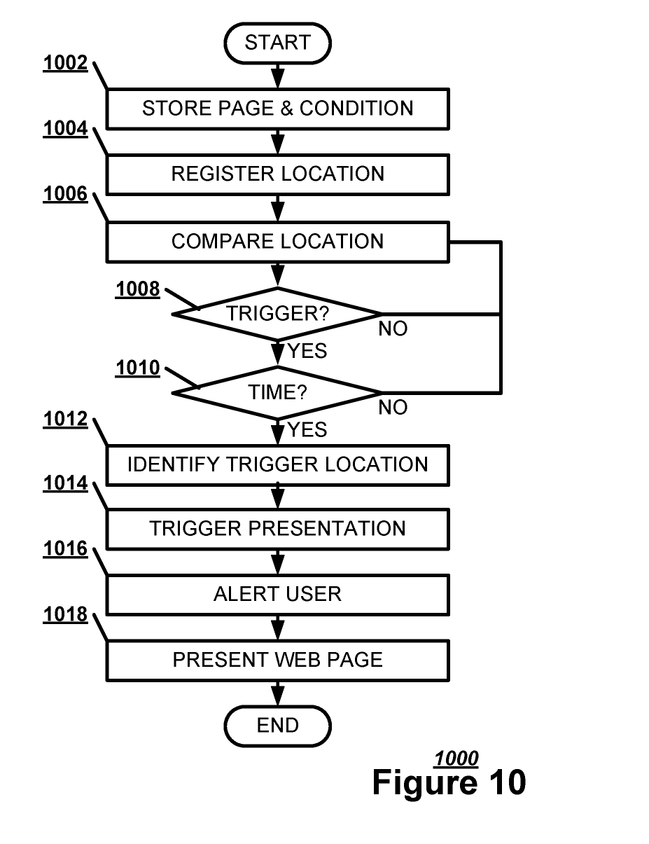

FIG. 10 illustrates, in a flowchart, one example of a method 1000 for activating a tab presentation based on a trigger location. The electronic assistant module executed by a mobile communication device may store a snooze profile having a web page and a trigger condition describing a trigger location (Block 1002). The electronic assistant module may register a geographic location of the mobile communication device (Block 1004). The electronic assistant module may compare the geographic location to the trigger location (Block 1006). If the geographic location meets the trigger condition as a trigger location (Block 1008), and the timing of the geographic location is within the time range (Block 1010), the electronic assistant module may identify the geographic location as a trigger location acting as a trigger event (Block 1012). The electronic assistant module may trigger presentation of the web page by the browser module to the user based on the geographic location (Block 1014). The electronic assistant module may alert a user that the web page is available for viewing upon triggering (Block 1016). The browser module may present the web page to a user on the mobile communication device based on the geographic location (Block 1018).

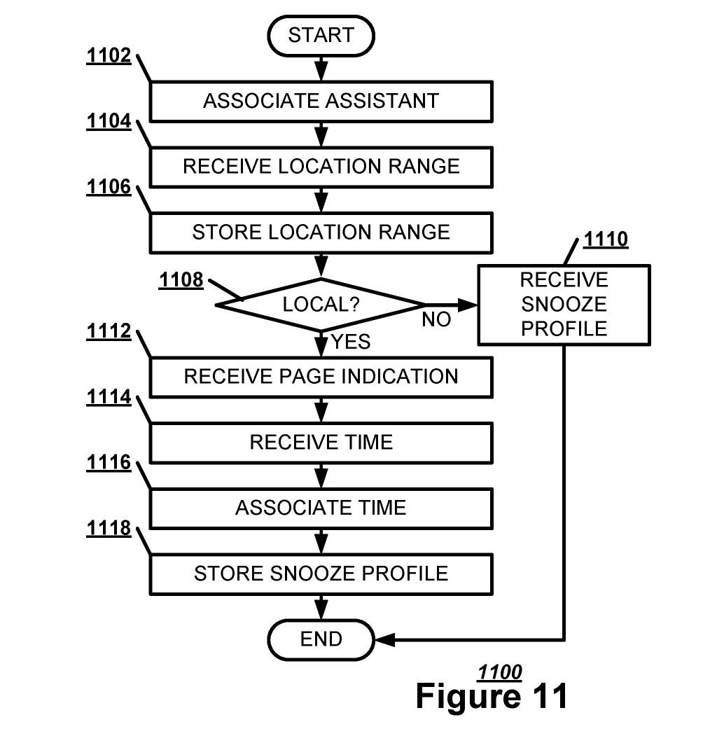

FIG. 11 illustrates, in a flowchart, one example of a method 1100 for setting a tab snooze based on a trigger time. An electronic assistant module of a computing device may associate with an online user account for a network service (Block 1102). The electronic assistant module may receive a location range for a tab snooze describing where an occurrence of a trigger event validly meets a trigger condition from the network service (Block 1104). The electronic assistant module may store a location range for a tab snooze describing where an occurrence of a trigger event validly meets a trigger condition on the computing device (Block 1106). If a different computing device associated with the user has set a tab snooze (Block 1108), the electronic assistant module may receive a snooze profile having a web page and a trigger condition describing a trigger time from a network service (Block 1110). Otherwise, the electronic assistant module or a browser module may receive a page indication identifying a web page (Block 1112). The electronic assistant module or the browser module may receive a trigger indication describing a trigger condition describing a trigger time (Block 1114). The electronic assistant module may associate the trigger condition describing the trigger time with the web page (Block 1116). The electronic assistant module may store a snooze profile having the web page associated with a trigger condition describing a trigger time as a trigger event (Block 1118).

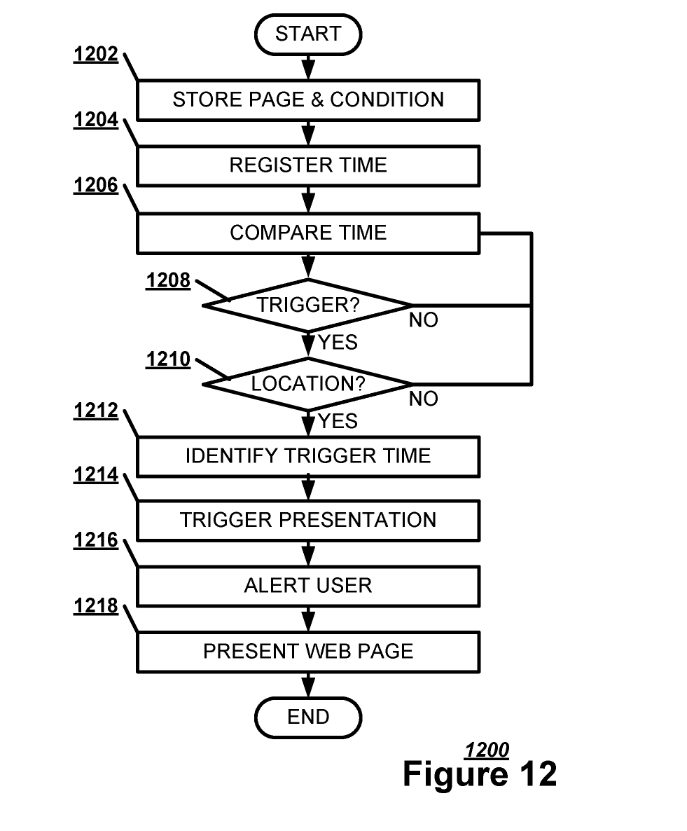

FIG. 12 illustrates, in a flowchart, one example of a method 1200 for 820activating a tab presentation based on a trigger time. The electronic assistant module executed by a mobile communication device may store a snooze profile having a web page and a trigger condition describing a trigger time as a trigger event (Block 1202). The electronic assistant module may register a time with the mobile communication device (Block 1204). The electronic assistant module may compare the time to the trigger time (Block 1206). If the time meets the trigger condition as a trigger time (Block 1208), and the computing device is within the location range (Block 1210), the electronic assistant module may identify the time on the computing device as a trigger time acting as a trigger event (Block 1212). The electronic assistant module may trigger presentation of the web page by the browser module to the user based on the time (Block 1214). The electronic assistant module may alert a user that the web page is available for viewing upon triggering (Block 1216). The browser module may present the web page to a user on the mobile communication device based on the time (Block 1218).

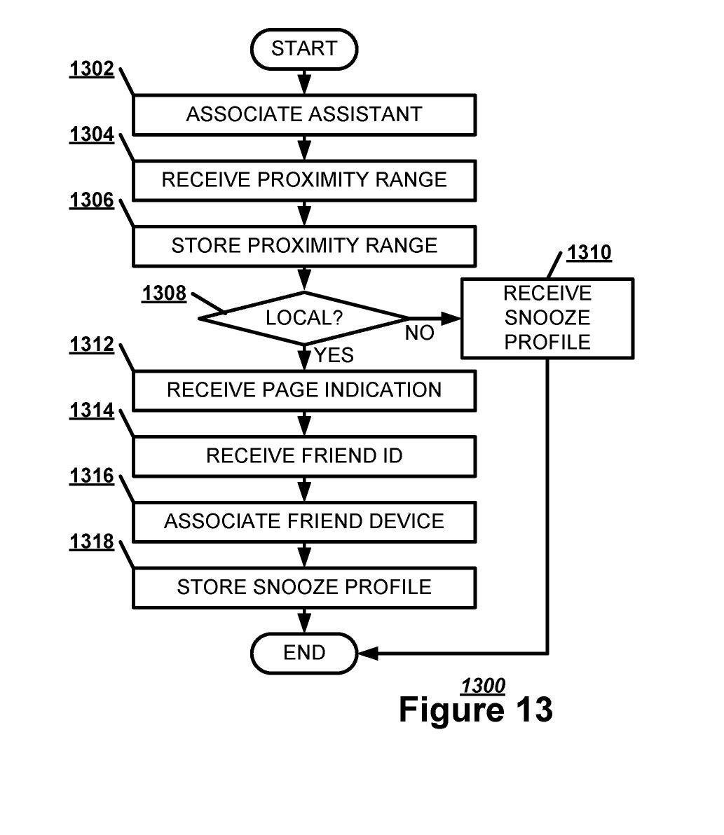

FIG. 13 illustrates, in a flowchart, one example of a method 1300 for setting a tab snooze based on a trigger device. An electronic assistant module of a computing device may associate with an online user account for a network service (Block 1302). The electronic assistant module may receive a proximity range for a tab snooze describing where an occurrence of a trigger event validly meets a trigger condition from the network service (Block 1304). The electronic assistant module may store a proximity range for a tab snooze describing where an occurrence of a trigger event validly meets a trigger condition on the computing device (Block 1306). If a different computing device associated with the user has set a tab snooze (Block 1308), the electronic assistant module may receive a snooze profile having a web page and a trigger condition describing a trigger device from a network service (Block 1310). Otherwise, the electronic assistant module or a browser module may receive a page indication identifying a web page (Block 1312). The electronic assistant module or the browser module may receive a trigger indication describing a trigger condition identifying a member of the contact list of the user (Block 1314). The electronic assistant module may associate the trigger condition identifying a friend device associated with the selected contact list member with the web page (Block 1316). The electronic assistant module may store a snooze profile having the web page associated with a trigger condition describing proximity to the friend device as a trigger event (Block 1318).

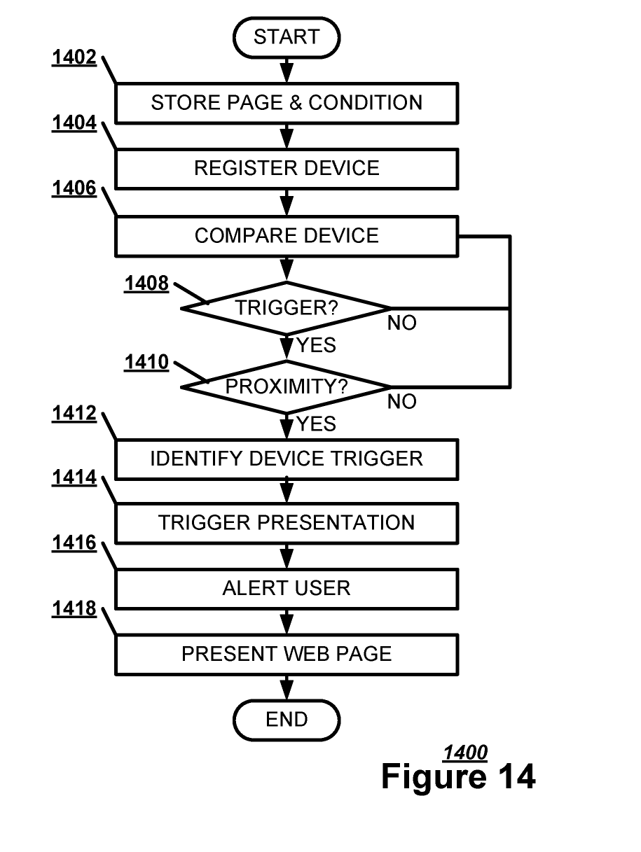

FIG. 14 illustrates, in a flowchart, one example of a method 1400 for activating a tab presentation based on a trigger device. The electronic assistant module executed by a mobile communication device may store a snooze profile having a web page and a trigger condition describing proximity to a friend device associated with a contact list member as a trigger event (Block 1402). The electronic assistant module may register the friend device as present with the mobile communication device (Block 1404). The electronic assistant module may compare the friend device to the trigger condition (Block 1406). If the friend device meets the trigger condition as a trigger device (Block 1408), and the friend device is within the proximity range of the mobile communication device (Block 1410), the electronic assistant module may identify the friend device paired with a contact list member within a proximity range as a trigger event (Block 1412). The electronic assistant module may trigger presentation of the web page by the browser module to the user based on the time (Block 1414). The electronic assistant module may alert a user that the web page is available for viewing upon triggering (Block 1416). The browser module may present the web page to a user on the mobile communication device based on the trigger device (Block 1418).

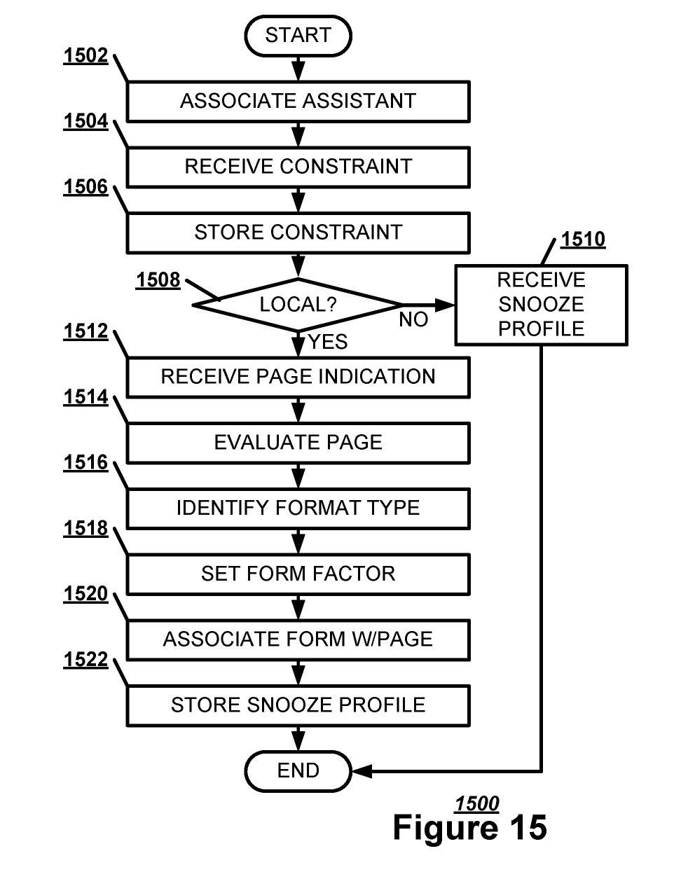

FIG. 15 illustrates, in a flowchart, one example of a method 1500 for setting a tab snooze based on a form factor trigger. An electronic assistant module executed by a computing device may associate with an online user account for a network service (Block 1502). The electronic assistant module may receive a generic constraint describing conditions for a trigger condition to be in effect for a tab snooze from the network service (Block 1504). The electronic assistant module may store a generic constraint for a tab snooze on the local device (Block 1506). If a different computing device associated with the user has set a tab snooze (Block 1508), the electronic assistant module may receive a snooze profile having a web page and a trigger condition describing a form factor trigger from a network service (Block 1510). Otherwise, the electronic assistant module or a browser module may receive a page indication identifying a web page (Block 1512). The electronic assistant module or the browser module may evaluate a web page based on a page profile (Block 1514). The electronic assistant module may identify a format type for the web page (Block 1516). The electronic assistant module may set a device form factor as a trigger condition based on a format type for the web page (Block 1518). The electronic assistant module may associate the trigger condition describing device form factor with the web page (Block 1520). The electronic assistant module may store a snooze profile having the web page and the trigger condition describing the device form factor (Block 1522).

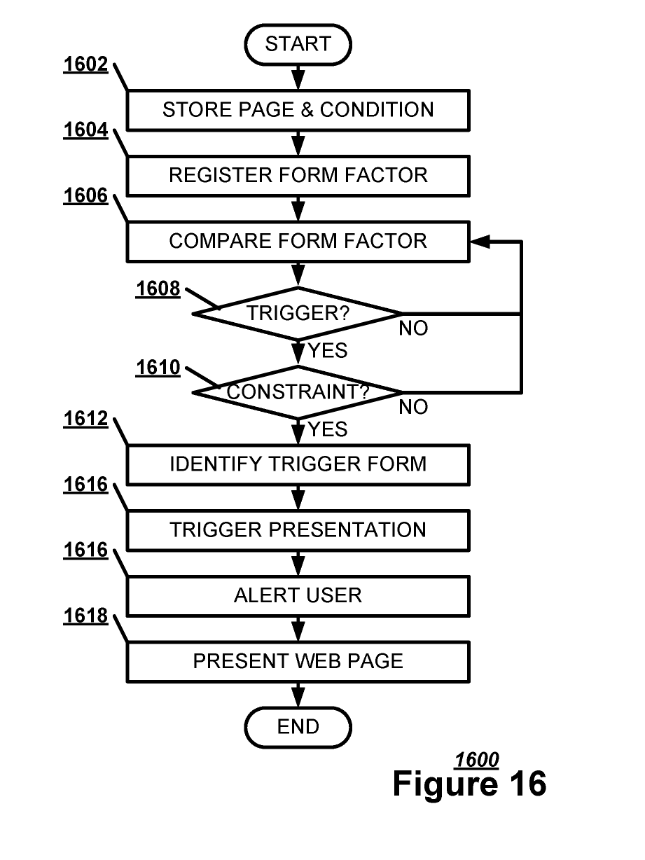

FIG. 16 illustrates, in a flowchart, one example of a method 1600 for activating a tab presentation based on a device form factor. The electronic assistant module may store a snooze profile having a web page and a trigger condition describing a device form factor (Block 1602). The electronic assistant module may register a device form factor upon activation of the computing device (Block 1604). The electronic assistant module may compare the device form factor to the trigger condition (Block 1606). If the device form factor meets the trigger condition (Block 1608), and the device activation is within a generic trigger constraint (Block 1610), the electronic assistant module may identify the device form factor as a trigger event (Block 1612). The electronic assistant module may trigger presentation of the web page by the browser module to the user based on the device form factor (Block 1614). The electronic assistant module may alert a user that the web page is available for viewing upon triggering (Block 1616). The browser module may present the web page to a user based on the trigger event (Block 1618).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Examples within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Examples may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described examples are part of the scope of the disclosure. For example, the principles of the disclosure may be applied to each individual user where each user may individually deploy such a system. This enables each user to utilize the benefits of the disclosure even if any one of a large number of possible modules do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A mobile communication device, comprising:
a memory configured to associate a web page with a trigger condition describing a trigger location;
a geographic positioning module configured to determine a geographic location of the mobile communication device;
a processing core having at least one processor configured to compare the geographic location to the trigger location; and
a display screen configured to present the web page to a user on the mobile communication device based on the geographic location.

2. The mobile communication device of claim 1, further comprising:
an input device configured to receive a page indication identifying the web page.

3. The mobile communication device of claim 1, further comprising:
an input device configured to receive a trigger indication describing the trigger condition.

4. The mobile communication device of claim 1, wherein the processing core is further configured to execute an electronic assistant module to track the web page.

5. The mobile communication device of claim 1, further comprising:
a communication interface configured to connect to an online user account for a network service using an electronic assistant module.

6. The mobile communication device of claim 1, further comprising:
a communication interface configured to receive the web page and the trigger condition in the electronic assistant module from a network service.

7. The mobile communication device of claim 1, wherein the memory is further configured to store a time range describing when the trigger location triggers presenting the web page.

8. The mobile communication device of claim 1, wherein the processing core is further configured to identify a content type for the web page.

9. The mobile communication device of claim 1, wherein the processing core is further configured to set a location type as the trigger condition based on a content type for the web page.

10. A computing device, having a memory to store a series of instructions that when implemented by a processing core implement an electronic assistant module, the computing device configured to
associate the electronic assistant module with an online user account for a network service;
store in the electronic assistant module a web page associated with a trigger condition describing a trigger event;
register a computing event has occurred;
identify the computing event as the trigger event;
trigger, with the electronic assistant module, presentation of the web page to the user based on the trigger event; and
present the web page to a user upon triggering.

11. The computing device of claim 10, wherein the computing device is further configured to
alert the user that the web page is available prior to presentation.

12. The computing device of claim 10, wherein the computing device is further configured to
store a time range describing when an occurrence of the trigger event validly meets the trigger condition.

13. The computing device of claim 10, wherein the computing device is further configured to
store a location range describing where an occurrence of the trigger event validly meets the trigger condition.

14. The computing device of claim 10, wherein the computing device is further configured to
identify a time of the mobile communication device as the trigger event.

15. The computing device of claim 10, wherein the computing device is further configured to
set a location type as the trigger condition based on a content type for the web page.

16. The computing device of claim 10, wherein the computing device is further configured to
identify a friend device paired with a contact list member within a proximity range as the trigger event.

17. The computing device of claim 10, wherein the computing device is further configured to
identify a device form factor as a trigger event.

18. The computing device of claim 10, wherein the computing device is further configured to
set a device form factor as a trigger condition based on a format type for the web page.

19. A machine-implemented method, comprising:
associating an electronic assistant module executed by a mobile communication device with an online user account for a network service;
receiving a web page and a trigger condition describing a trigger location in the electronic assistant module from a network service;
storing in the mobile communication device with the electronic assistant module the web page associated with the trigger condition;
registering a geographic location of the mobile communication device;
comparing the geographic location to the trigger location;
triggering, with the electronic assistant module, presentation of the web page to the user based on the geographic location; and
alerting a user that the web page is available for viewing upon triggering.

20. The method of claim 19, further comprising:
evaluating the web page with the electronic assistant module;
identifying a content type for the web page; and
setting a location type as the trigger condition based on the content type for the web page.
